(19) United States
(12) Patent Application Publication
(10) Pub. No.: US 2015/0058710 A1
(43) Pub. Date: Feb. 26, 2015

(54) NAVIGATING FIXED FORMAT DOCUMENT IN E-READER APPLICATION

(71) Applicant: Microsoft Corporation, Redmond, WA (US)

(72) Inventors: Seth Robert Atkinson, Redmond, WA (US); Wei Zeng, Sammamish, WA (US); Raman Narayanan, Seattle, WA (US); Ming Liu, Bellevue, WA (US); Aleksandr Gil, Redmond, WA (US); Renee Choy Yang, Seattle, WA (US)

(73) Assignee: Microsoft Corporation, Redmond, WA (US)

(21) Appl. No.: 13/972,755

(22) Filed: Aug. 21, 2013

(51) Int. Cl. G06F 17/21; G06F 17/24

(52) U.S. Cl. CPC G06F 17/212; G06F 17/241
USPC 715/230; 715/234

(57) ABSTRACT

An e-reader application displays a page of a fixed format document resized to match a size of a window pane in a fit page format. The e-reader application presents selection controls associated with a selection action in response to detecting the selection action on a text of the page. In addition, an operation associated with a navigation action is executed in response to detecting the navigation action on the page.

### BACKGROUND

People interact with computer applications through user interfaces. While audio, tactile, and similar forms of user interfaces are available, visual user interfaces through a display device are the most common form of a user interface. With the development of faster and smaller electronics for computing devices, smaller size devices such as handheld computers, smart phones, tablet devices, and comparable devices have become common. Such devices execute a wide variety of applications ranging from communication applications to complicated analysis tools. Many such applications render visual effects through a display and enable users to provide input associated with the applications' operations.

Recently, devices of limited display size have penetrated the customer markets successfully. In some instances, limited purpose devices such as tablets have replaced multipurpose devices such as laptops for use in media consumption. Another consumer consumption pattern shifting towards limited purpose devices includes consumption of fixed format documents. Fixed format documents assemble content to resemble paper productions. Such documents provide a familiar format to the user. In addition, added features such as altering font type attributes improve on user interactivity compared to traditional sources of media such as paper productions. However, applications presenting fixed format documents are unable to re-assemble the contents of the documents to match the display size limitations of devices presenting the documents. Display size limitations may inconvenience users by displaying small portions of the fixed format documents and forcing users to scroll endlessly to reach desired content. Extensive scroll action involving multiple user actions may inhibit consumption flow and diminish user experience while consuming a content.

### SUMMARY

This summary is provided to introduce a selection of concepts in a simplified form that are further described below in the Detailed Description. This summary is not intended to exclusively identify key features or essential features of the claimed subject matter, nor is it intended as an aid in determining the scope of the claimed subject matter.

Embodiments are directed to navigating a fixed format document in an e-reader application. According to some embodiments, an electronic reader (e-reader) application may display a page of a fixed format document resized to match a size of a window pane of the e-reader application in a fit to page format. The window pane may be sized to match a screen area of a device presenting the e-reader application. Subsequently, the e-reader application may detect a selection action on a text of the page. The text may be highlighted and boundary controls may be provided at ends of the highlighted text. The e-reader application may present additional controls associated with the selection action. The additional controls may include a lookup, an annotation, a search, a highlight, and a define (dictionary definition) control which may initiate associated operation upon activation.

Next, the e-reader application may detect a navigation action on the page. The navigation action may include a page turn action. An operation associated with the navigation action may be based on number of displayed pages. The number of displayed pages may include one page or two pages. The e-reader application may next execute the operation associated with the navigation action. The window pane of the e-reader application may be refreshed with a modified page or with an another page(s).

These and other features and advantages will be apparent from a reading of the following detailed description and a review of the associated drawings. It is to be understood that both the foregoing general description and the following detailed description are explanatory and do not restrict aspects as claimed.

### BRIEF DESCRIPTION OF THE DRAWINGS

FIG. 1 illustrates an example concept diagram of navigating a fixed format document in an e-reader application according to some embodiments;

FIG. 2 illustrates an example of an e-reader application detecting actions associated with navigating a page of a fixed format document according to embodiments;

FIG. 3 illustrates an example of an e-reader application presenting controls associated with a selection action on a text of a displayed page according to embodiments;

FIG. 4 illustrates an example of an e-reader application presenting controls associated with a search action according to embodiments;

FIG. 5 is a networked environment, where a system according to embodiments may be implemented;

FIG. 6 is a block diagram of an example computing operating environment, where embodiments may be implemented; and

FIG. 7 illustrates a logic flow diagram for a process navigating a fixed format document in an e-reader application according to embodiments.

### DETAILED DESCRIPTION

As briefly described above, a fixed format document may be navigated within an e-reader application. An e-reader application may display a page of the fixed format document resized to match a size of a window pane in a fit page format. Controls associated with a selection action may be present in response to detecting the selection action on content of the page. An operation associated with a navigation action may be executed in response to detecting the navigation action on the page.

In the following detailed description, references are made to the accompanying drawings that form a part hereof, and in which are shown by way of illustrations specific embodiments or examples. These aspects may be combined, other aspects may be utilized, and structural changes may be made without departing from the spirit or scope of the present disclosure. The following detailed description is therefore not to be taken in a limiting sense, and the scope of the present disclosure is defined by the appended claims and their equivalents.

While the embodiments will be described in the general context of program modules that execute in conjunction with an application program that runs on an operating system on a computing device, those skilled in the art will recognize that aspects may also be implemented in combination with other program modules.

Generally, program modules include routines, programs, components, data structures, and other types of structures that perform particular tasks or implement particular abstract data types. Moreover, those skilled in the art will appreciate that embodiments may be practiced with other computer system configurations, including hand-held devices, multiprocessor systems, microprocessor-based or programmable consumer electronics, minicomputers, mainframe computers, and comparable computing devices. Embodiments may also be practiced in distributed computing environments where tasks are performed by remote processing devices that are linked through a communications network. In a distributed computing environment, program modules may be located in both local and remote memory storage devices.

Embodiments may be implemented as a computer-implemented process (method), a computing system, or as an article of manufacture, such as a computer program product or computer readable media. The computer program product may be a computer storage medium readable by a computer system and encoding a computer program that comprises instructions for causing a computer or computing system to perform example process(es). The computer-readable storage medium is a computer-readable memory device. The computer-readable storage medium can for example be implemented via one or more of a volatile computer memory, a non-volatile memory, a hard drive, a flash drive, a floppy disk, or a compact disk, and comparable media.

Throughout this specification, the term “platform” may be a combination of software and hardware components for navigating a fixed format document in an e-reader application. Examples of platforms include, but are not limited to, a hosted service executed over a plurality of servers, an application executed on a single computing device, and comparable systems. The term “server” generally refers to a computing device executing one or more software programs typically in a networked environment. However, a server may also be implemented as a virtual server (software programs) executed on one or more computing devices viewed as a server on the network. More detail on these technologies and example operations is provided below.

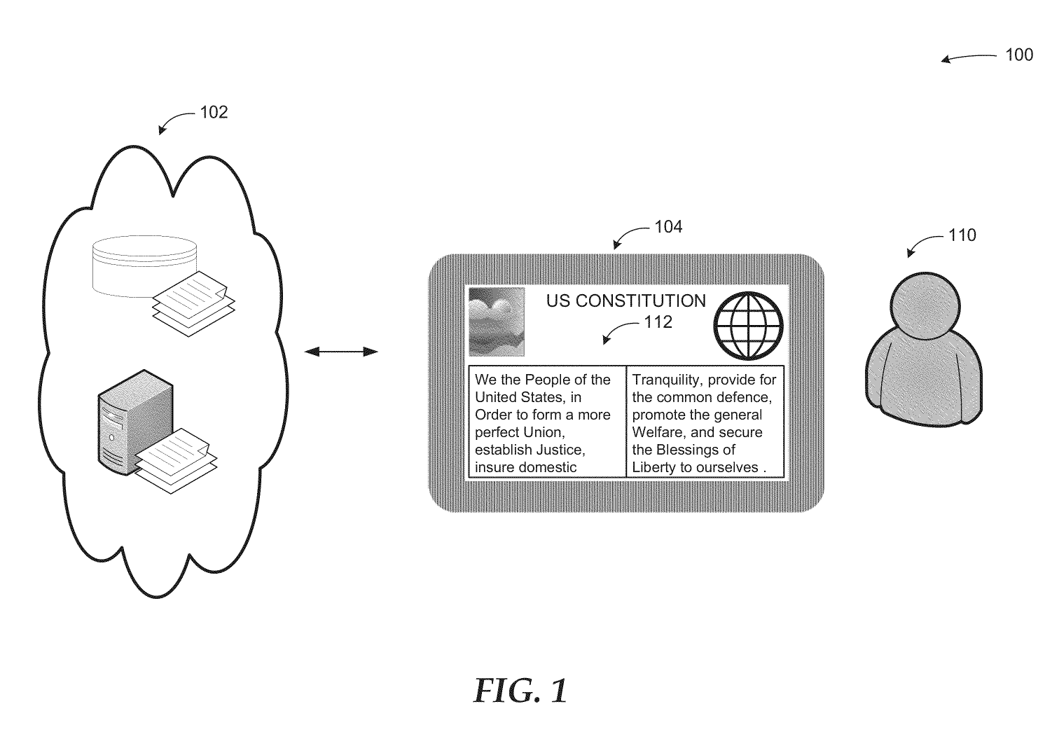

FIG. 1 illustrates an example concept diagram of navigating a fixed format document in an e-reader application according to some embodiments. The components and environments shown in diagram 100 are for illustration purposes. Embodiments may be implemented in various local, networked, cloud-based and similar computing environments employing a variety of computing devices and systems, hardware and software.

A device 104 may display a page 112 of a fixed format document through a window pane of an e-reader application. Alternatively, the e-reader application may display two pages in the window pane. The fixed format document may include a document formatted to resemble paper productions such as pages of a paper book, a journal, and similar ones. The e-reader application may detect actions on the page 112 associated with navigating the fixed format document. The device 104 may recognize the navigation actions through its hardware capabilities which may include a camera, a microphone, a touch-enabled screen, a keyboard, a mouse, and comparable ones.

The device 104 may communicate with external resources such as a cloud-hosted platform 102 to present the page 112. In an example scenario, the device 104 may retrieve a fixed format document from the external resources. The cloud-hosted platform 102 may include remote resources such as data stores and content servers. The page 112 may be retrieved from the fixed format document. The page 112 may be sized to match the screen size of the window pane of the e-reader document in a fit page format.

Embodiments are not limited to implementation in a device 104 such as a tablet. The e-reader application, according to embodiments, may be a local application executed in any device capable of displaying the application. Alternatively, the e-reader application may be a hosted application such as a web service which may execute in a server while displaying application content through a client user interface such as a web browser. In addition to a touch-enabled device 104, interactions with the page 112 may be accomplished through other input mechanisms such as an optical gesture capture, a gyroscopic input device, a mouse, a keyboard, an eye-tracking input, and comparable software and/or hardware based technologies.

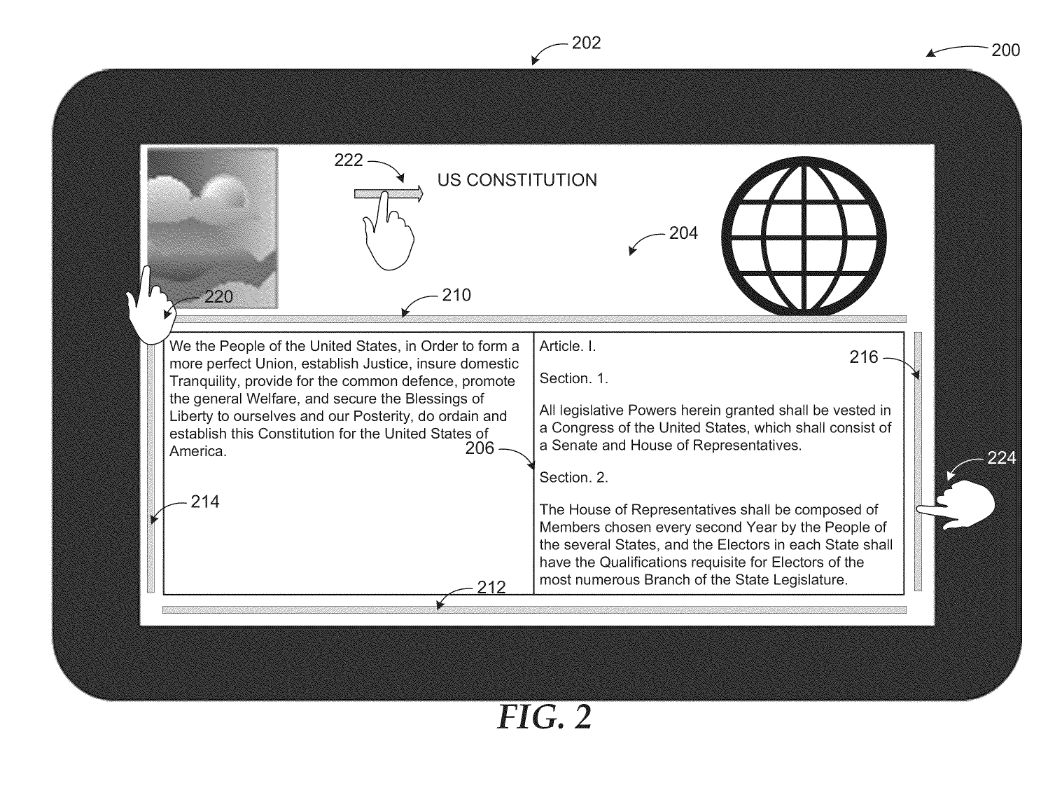

FIG. 2 illustrates an example of an e-reader application detecting actions associated with navigating a page of a fixed format document according to embodiments. Diagram 200 displays the e-reader application within a device 202 such as a tablet. The e-reader application may display a page of a fixed format document resized to match a screen size of a window pane of the e-reader application in a fit page format.

The e-reader application may present the page 204 in the fit page format by default. The fit page format may resize the page 204 to match the size of the window pane of the e-reader application. Alternatively, two pages of the fixed format document may be displayed in a fit page format in response to a user selection changing a display attribute of the e-reader application. In yet another scenario, the e-reader application may be instructed to display a page in a fit width format. The e-reader may change the size of the page 204 to align left and right boundaries of the page 204 with a right and left edge of the window pane of the e-reader application. If the height of the page 204 may not fit into the window pane, then the e-reader application may provide vertical scroll bars to navigate to hidden sections of the page 204.

While displaying a page or two pages in a fit page or fit width format, the e-reader application may detect a right swipe action 222 on the page 204. The e-reader may interpret the swipe action as a page turn action and execute an operation associated with the page turn action. The right swipe action 222 may be interpreted to display a previous page and a left swipe action may be interpreted to display a next page.

Alternatively, a tap action 220 detected in proximity to the right edge of the window pane may be interpreted as a page turn action. A tap action in proximity to the right edge of the window pane may be interpreted to display a next page. A tap action in proximity to the left edge of the window pane may interpreted to display a previous page.

In another scenario, a zoom out action may be limited to a maximum setting of a fit page format. The e-reader application may execute an operation associated with the zoom out action to contract the page in a location associated with the zoom out action. When displaying the page 204 in a fit page format, the application may prevent execution of an operation associated with additional zoom out actions. Alternatively, a zoom in action may be limited to a 4× scale of the fit page format used to display the page 204. The e-reader application may execute an operation associated with the zoom in action to expand the page 204 centered on a location of the zoom in action. The e-reader application may prevent execution of an operation associated with additional zoom in actions beyond the 4× scale. The e-reader application may detect a finger spread action as a zoom in action and a finger pinch action as a zoom out action.

According to some embodiments, the page 204 may be displayed in a zoomed in format within the window pane of the e-reader application hiding sections of the page 204. When displaying the page 204 in a zoomed in format, the navigation actions such as a tap action on a left or a right edge of the window pane or a right or left swipe action may be interpreted to display an adjacent hidden section of the page 204. The navigation actions may be interpreted as a page turn action in response to reaching a left or a right boundary of the page 204 and detecting the navigation action corresponding to a page turn operation.

Navigation actions are not limited to touch based gestures. A keyboard input such as a left or a right arrow, a page down, or a page up action may initiate a navigation action associated with the input. The e-reader application may display a beginning of a next page when detecting a page down action. A beginning of a previous page may be displayed when detecting a page up action. A right arrow or a down arrow action may be interpreted to display a next page. A left arrow and an up arrow action may be interpreted to display a previous page.

In addition, the e-reader application may utilize rails 210, 212, 214, and 216 as boundary regions to align a section of text associated with the body section 206 of the page 204 within edges of the window pane of the e-reader application. The e-reader application may determine a body section 206 of the page 204 through identification tags encompassing the body section 206 or an optical character recognition (OCR) algorithm identifying the text of the body section 206. The e-reader application may mark external boundaries of the body section 206 with rails 210, 212, 214, and 216. The e-reader application may use the rails to expand the body section 206 to encompass the window pane.

The e-reader application may align the body section 206 with at least one edge of the window pane of the e-reader application in response to detecting a navigation action in proximity to a rail. In an example scenario, the e-reader application may detect a navigation action in proximity of the rail 210. The e-reader may resize the body section 206 to start from a top edge of the window pane and move the left boundary of the body section 206 to the left edge of the window pane while moving the right boundary of the body section 206 to the right edge of the window pane. As a result, the e-reader application may resize the body section to align boundaries perpendicular to the rail to parallel edges of the window pane while maintaining aspect ratio of the body section without expanding the body section beyond edges of the window pane. A navigation action on one of the rails 210, 212, 214, and 216 thus serves to align the body section 206 on an edge of the window pane while utilizing a maximum screen area within the window pane to display the body section 206 while maintaining an aspect ratio of the body section 206.

Embodiments are not limited to example scenarios described above. The navigation actions may be interpreted alternatively based on a localization setting of the e-reader application. In an example scenario, the e-reader application may interpret a right swipe action to display a next page when detecting a localization setting for a language with a right to left reading direction.

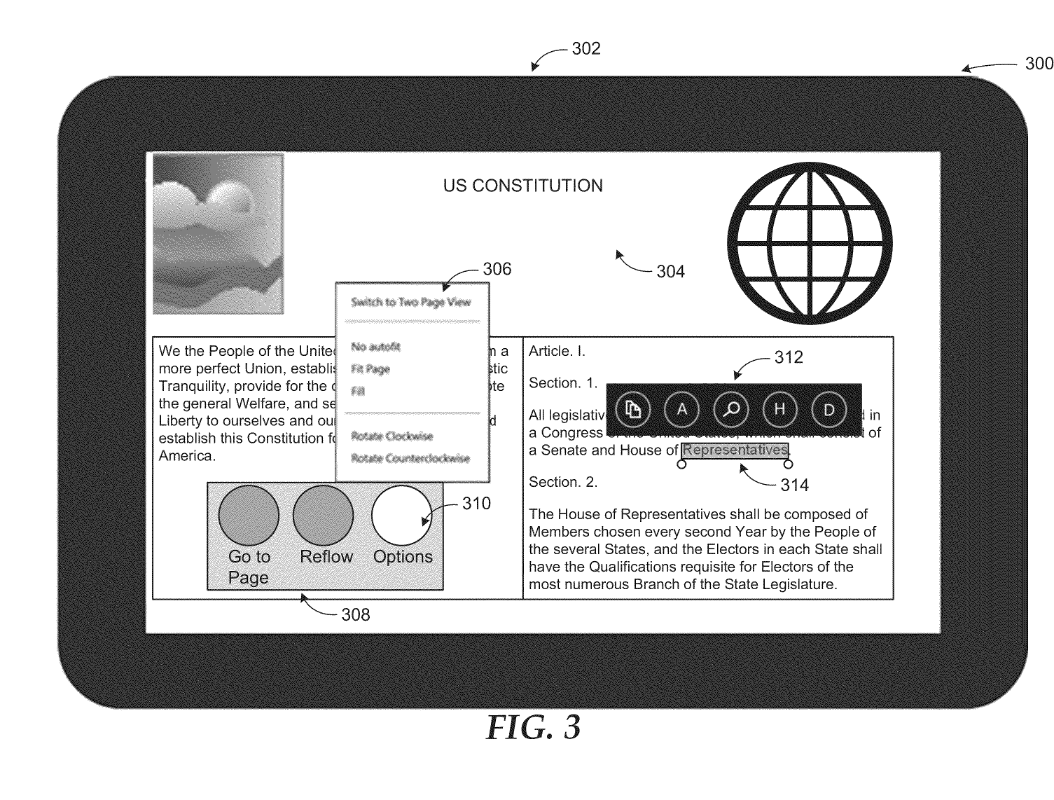

FIG. 3 illustrates an example of an e-reader application presenting controls associated with a selection action on a text of a displayed page according to embodiments. Diagram 300 displays an example of a view option control 308 and selection controls 302 and boundary controls.

According to some embodiments, the e-reader application may display a view option control 308 in response to a user action. The view option control 308 may present a go to page control. In response to an activation, the e-reader application may execute an operation associated with the go to page control to hide the view option control 308 and display the page 304. The view option control may also present a reflow control. If activated, an operation associated with the reflow control may launch another window pane on top of the page 304 displaying title and body sections of the page 304.

In addition, the view option control 310 may also present an options control. When activated, the e-reader application may execute an operation associated with the options control to display the view option menu 306. The view option menu may provide additional controls to adjust attributes of the e-reader application. The additional controls may include a switch to a two page view control, a no autofit control, a fit page control, a fit width control, a rotate clockwise control, and a rotate counterclockwise control. When activated, the e-reader application may execute an operation associated with each additional control.

In an example scenario, the e-reader application may display another page adjacent to the page 304 in the window pane upon activation of the switch to two page view control. The e-reader application may disable fit page format based resizing of the page 304 to the window pane of the e-reader application upon activation of the no auto-fit control. The page 304 may be resized to fit the window pane of the e-reader application upon activation of the fit page control. In addition, the e-reader application may fit a width of the page 304 to the window pane of the e-reader application in response to activation of the associated fit width control.

The e-reader application may rotate the page (304) 90 degrees in a clockwise direction in response to activation of the rotate clockwise control. The page 304 may be rotated 90 degrees in a counterclockwise direction in response to activation of the rotate counterclockwise control.

According to other embodiments, the e-reader application may detect a selection action 314 on the page 304. The selection action may include a tap action on content of the page 304 such as an image or a word of the page 304 or a left mouse click on a word of the page 304. In response to the selection action, the e-reader application may highlight the text and provide boundary controls at either end of the text to expand or contract a selection associated with the selection action. In addition, the e-reader application may also display selection controls 312 associated with the selection action 314.

The selection controls 312 may include a lookup control to display inline insights about the selected text. In addition, the selection controls may include an annotation control to add an annotation to the selected text. Furthermore, the selection controls may include a search control to search the selected text within the fixed format document. Additionally, the selection controls may include highlight control to highlight the selected text. Furthermore, the selection controls may include a define control to display a dictionary definition of the selected text.

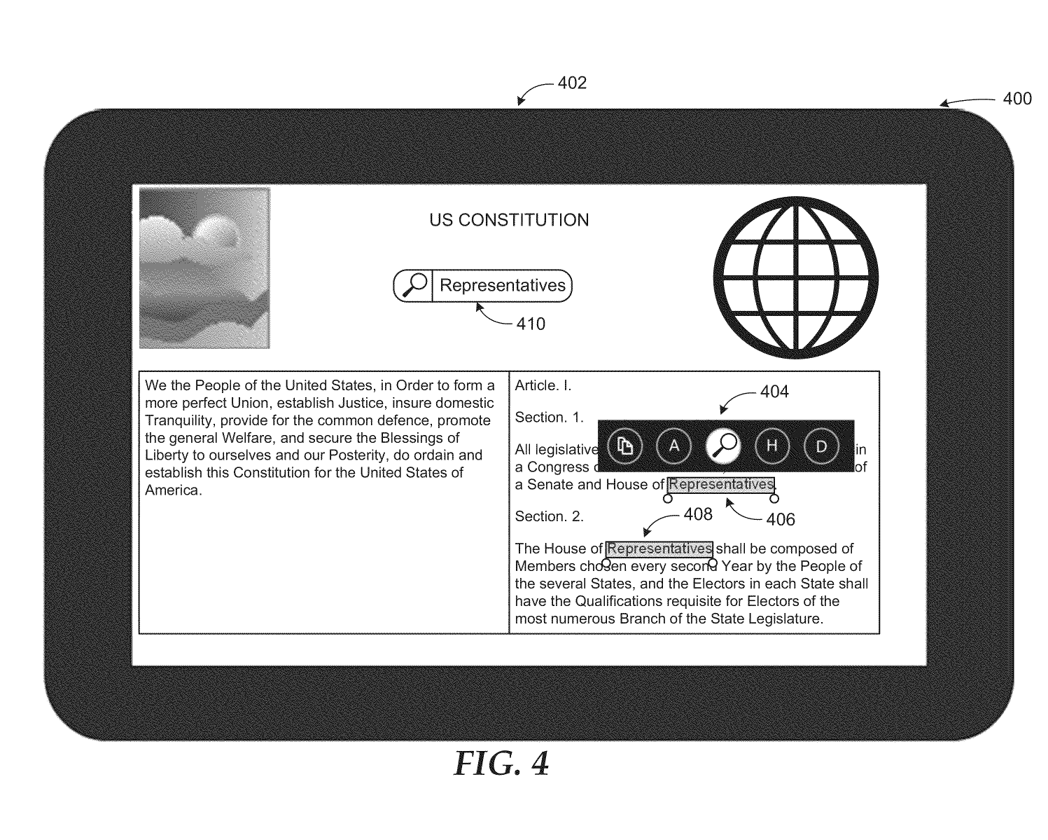

FIG. 4 illustrates an example of an e-reader application presenting controls associated with a search action. Diagram 400 displays a device 402 providing controls associated with a search action.

In response to a selection action 406, the e-reader application may provide selection controls 404. Next, the e-reader application may detect activation of a search control within the selection controls 404. A search operation associated with the search control may be executed. A search box including the selected text may be displayed. A user may be enabled to modify the selected text and re-execute the search operation using the modified text through another search control in the search box 410.

In addition, the e-reader application may execute a search operation to find text matching the selected text in the fixed format document. Matching text 408 may be highlighted to indicate a term matching the selected text. Additional matching text in subsequent pages may also be highlighted in response to navigation actions displaying the subsequent pages.

According to yet other embodiments, the e-reader application may analyze the page for content not associated with a body section of the page. The e-reader application may filter the page by removing content including an advertising, an annotation, and similar ones. The filtered page may be rendered absent the content not associated with the body section of the page.

The example scenarios and schemas in FIG. 2 through 4 are shown with specific components, data types, and configurations. Embodiments are not limited to systems according to these example configurations. Navigating a fixed format document in an e-reader application may be implemented in configurations employing fewer or additional components in applications and user interfaces. Furthermore, the example schema and components shown in FIG. 2 through 4 and their subcomponents may be implemented in a similar manner with other values using the principles described herein.

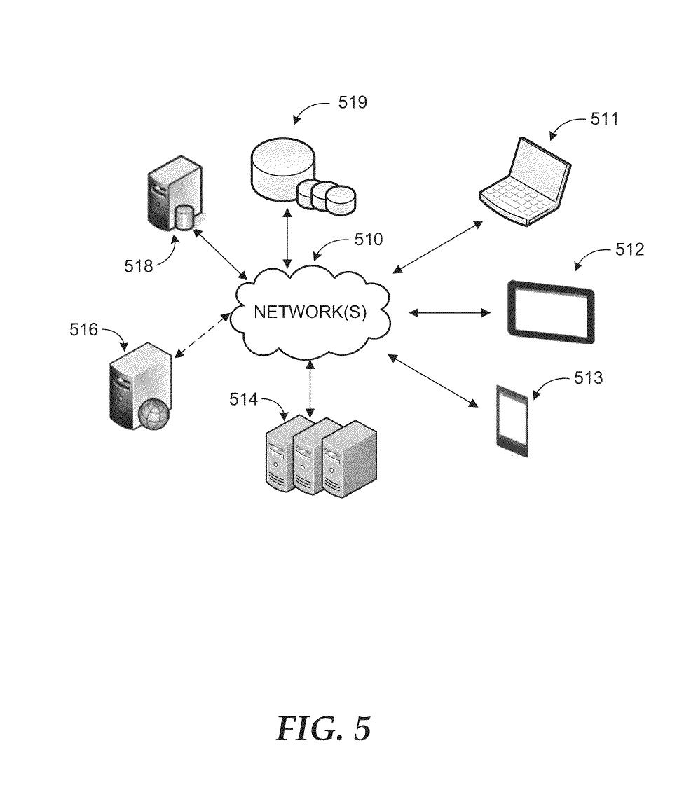

FIG. 5 is a networked environment, where a system according to embodiments may be implemented. Local and remote resources may be provided by one or more servers 514 or a single server (e.g. web server) 516 such as a hosted service. An application may execute on individual computing devices such as a smart phone 513, a tablet device 512, or a laptop computer 511 (‘client devices’) and retrieve fixed format documents intended for display through network(s) 510.

As discussed above, a fixed format document may be navigated in an e-reader application. The e-reader application may display a page of the fixed format document resized to match a size of a window pane in a fit page format. Controls associated with a selection action may be presented in response to detecting the selection action on a text of the page. In addition, an operation associated with a navigation action may be executed in response to detecting the navigation action on the page. Client devices 511-513 may enable access to applications executed on remote server(s) (e.g. one of servers 514) as discussed previously. The server(s) may retrieve or store relevant data from/to data store(s) 519 directly or through database server 518.

Network(s) 510 may comprise any topology of servers, clients, Internet service providers, and communication media. A system according to embodiments may have a static or dynamic topology. Network(s) 510 may include secure networks such as an enterprise network, an unsecure network such as a wireless open network, or the Internet. Network(s) 510 may also coordinate communication over other networks such as Public Switched Telephone Network (PSTN) or cellular networks. Furthermore, network(s) 510 may include short range wireless networks such as Bluetooth or similar ones. Network(s) 510 provide communication between the nodes described herein. By way of example, and not limitation, network(s) 510 may include wireless media such as acoustic, RF, infrared and other wireless media.

Many other configurations of computing devices, applications, data resources, and data distribution systems may be employed to navigate a fixed format document in an e-reader application. Furthermore, the networked environments discussed in FIG. 5 are for illustration purposes only. Embodiments are not limited to the example applications, modules, or processes.

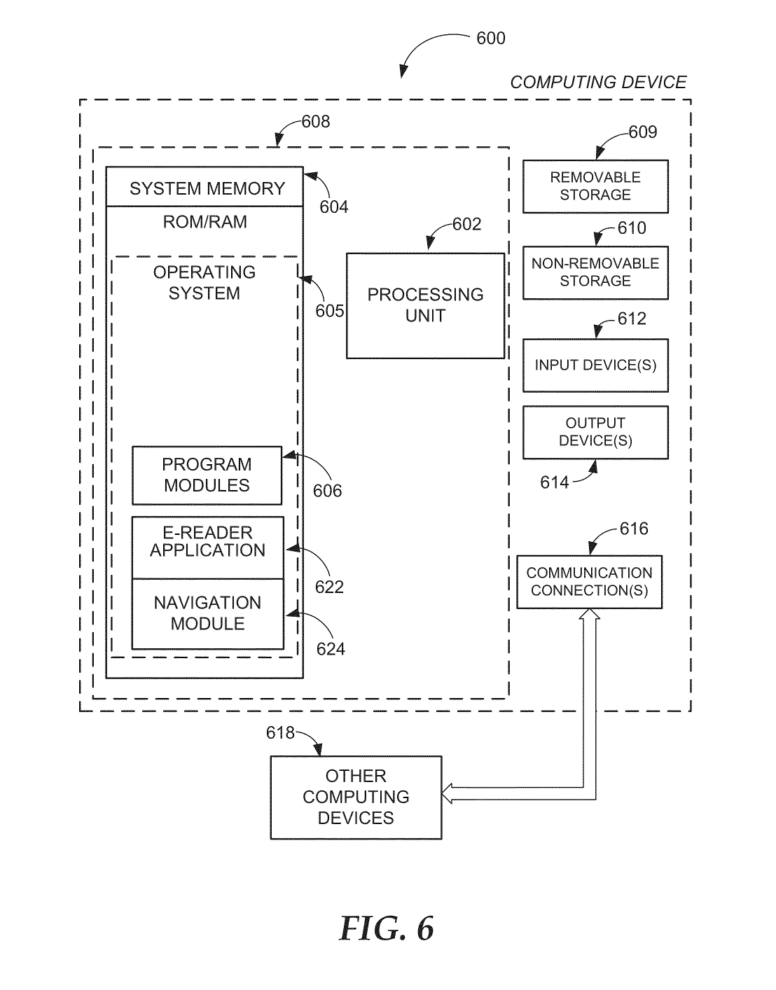

FIG. 6 and the associated discussion are intended to provide a brief, general description of a suitable computing environment in which embodiments may be implemented. With reference to FIG. 6, a block diagram of an example computing operating environment for an application according to embodiments is illustrated, such as computing device 600. In a basic configuration, computing device 600 may include at least one processing unit 602 and system memory 604. Computing device 600 may also include a plurality of processing units that cooperate in executing programs. Depending on the exact configuration and type of computing device, the system memory 604 may be volatile (such as RAM), non-volatile (such as ROM, flash memory, etc.) or some combination of the two. System memory 604 typically includes an operating system 605 suitable for controlling the operation of the platform, such as the WINDOWS® and WINDOWS PHONE® operating systems from MICROSOFT CORPORATION of Redmond, Wash. The system memory 604 may also include one or more software applications such as program modules 606, an e-reader application 622, and a navigation module 624.

An e-reader application 622 may display a page of a fixed document resized to match a size of a window pane of the e-reader application 622 in a fit page format. The e-reader application 622 may present controls associated with a selection action in response detecting the action on a text of the page in a screen of the device 600, in proximity. The navigation module 624 may execute an operation associated with a navigation action in response to the e-reader application 622 detecting the navigation action on the page. This basic configuration is illustrated in FIG. 6 by those components within dashed line 608.

Computing device 600 may have additional features or functionality. For example, the computing device 600 may also include additional data storage devices (removable and/or non-removable) such as, for example, magnetic disks, optical disks, or tape. Such additional storage is illustrated in FIG. 6 by removable storage 609 and non-removable storage 610. Computer readable storage media may include volatile and nonvolatile, removable and non-removable media implemented in any method or technology for storage of information, such as computer readable instructions, data structures, program modules, or other data. Computer readable storage media is a computer readable memory device. System memory 604, removable storage 609 and non-removable storage 610 are all examples of computer readable storage media. Computer readable storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by computing device 600. Any such computer readable storage media may be part of computing device 600. Computing device 600 may also have input device(s) 612 such as keyboard, mouse, pen, voice input device, touch input device, and comparable input devices. Output device(s) 614 such as a display, speakers, printer, and other types of output devices may also be included. These devices are well known in the art and need not be discussed at length here.

Computing device 600 may also contain communication connections 616 that allow the device to communicate with other devices 618, such as over a wireless network in a distributed computing environment, a satellite link, a cellular link, and comparable mechanisms. Other devices 618 may include computer device(s) that execute communication applications, storage servers, and comparable devices. Communication connection(s) 616 is one example of communication media. Communication media can include therein computer readable instructions, data structures, program modules, or other data in a modulated data signal, such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media.

Example embodiments also include methods. These methods can be implemented in any number of ways, including the structures described in this document. One such way is by machine operations, of devices of the type described in this document.

Another optional way is for one or more of the individual operations of the methods to be performed in conjunction with one or more human operators performing some. These human operators need not be co-located with each other, but each can be only with a machine that performs a portion of the program.

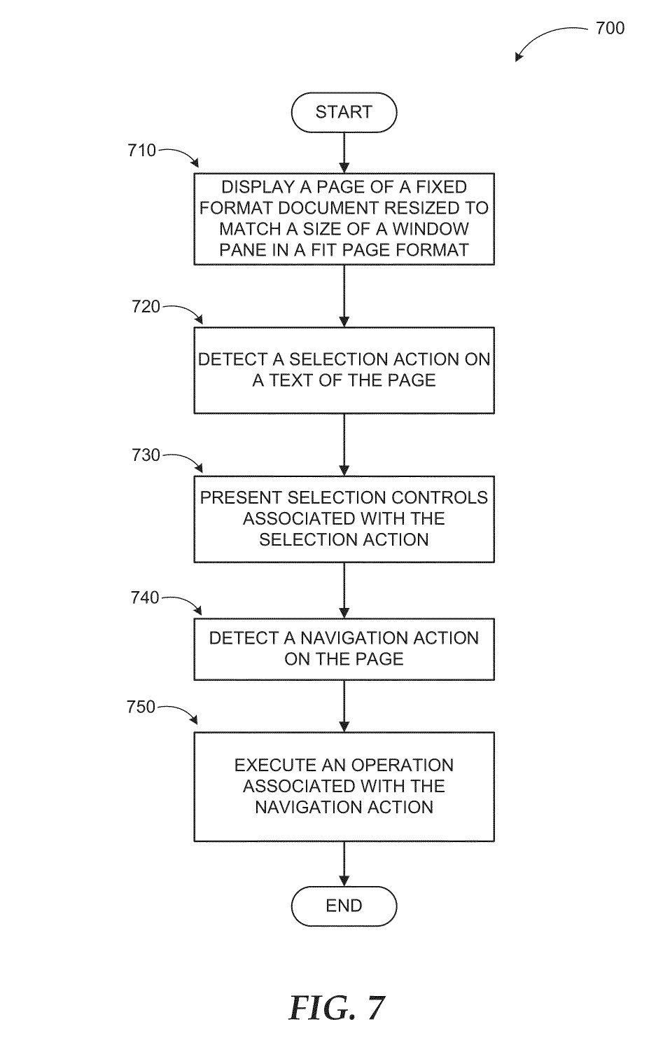

FIG. 7 illustrates a logic flow diagram for a process navigating a fixed format document in an e-reader application according to embodiments. Process 700 may be implemented by an e-reader application, in some examples.

Process 700 may begin with operation 710 where the e-reader application may display a page of a fixed format document resized to match a size of a window pane in a fit page format. Alternatively, an additional page may be displayed adjacent to the page to present a two page view. At operation 720, a selection action may be detected on a text of the page. An operation associated with the selection action may highlight the text. Next, the reader application may present controls associated with the selection action at operation 730. Boundary controls at ends of the text may be presented to expand or contract the selected text. At operation 740, a navigation action may be detected on the page. The navigation action may include a tap action, a swipe action, a keyboard input, and similar ones. Additionally, the e-reader application may execute an operation associated with the navigation action at operation 750.

Some embodiments may be implemented in a computing device that includes a communication module, a memory, and a processor, where the processor executes a method as described above or comparable ones in conjunction with instructions stored in the memory. Other embodiments may be implemented as a computer readable storage medium with instructions stored thereon for executing a method as described above or similar ones.

The operations included in process 700 are for illustration purposes. Navigating a fixed format document in an e-reader application, according to embodiments, may be implemented by similar processes with fewer or additional steps, as well as in different order of operations using the principles described herein.

The above specification, examples and data provide a complete description of the manufacture and use of the composition of the embodiments. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims and embodiments.

What is claimed is:

1. A method executed on a computing device for navigating a fixed format document in an e-reader application, the method comprising:
displaying a page of the fixed format document resized to match a size of a window pane in a fit page format;
detecting a selection action on a text of the page;
presenting selection controls associated with the selection action;
detecting a navigation action on the page; and
executing an operation associated with the navigation action.

2. The method of claim 1, further comprising:
inserting another page of the fixed format document adjacent to the page to display a two page view in the window pane in response to an activation of a two page view control.

3. The method of claim 1, further comprising:
changing a size of the page to align a right boundary of the page with a right edge of the window pane and left boundary of the page with a left edge of the window pane to display the page in a fit width format.

4. The method of claim 1, further comprising:
interpreting one of: a right swipe action on the page and a tap action in proximity to a left edge of the window pane as a page turn action to display a previous page; and
executing another operation associated with the page turn action to display the previous page.

5. The method of claim 1, further comprising:
interpreting one of: a left swipe action on the page and a tap action in proximity to a right edge of the window pane as a page turn action to display a next page; and
executing another operation associated with the page turn action to display the next page.

6. The method of claim 1, further comprising:
detecting a zoom in action including a finger spread action;
executing another operation associated with the zoom in action to expand the page; and
limiting the zoom in action to a 4X scale of the page in the fit page format.

7. The method of claim 6, further comprising:
detecting a zoom out action including a finger pinch action;
executing an operation associated with the zoom out action to contract the page in another location associated with the zoom out action; and
limiting the zoom out action to the fit page format.

8. The method of claim 1, further comprising:
determining a body section of the page by at least one of: identifying tags encompassing the body section and identifying the body section through an optical character recognition (OCR) algorithm.

9. The method of claim 8, further comprising:
marking external boundaries of the body section with rails.

10. The method of claim 9, further comprising:
detecting a navigation action in proximity to one of the rails; and
aligning the body section with an edge of the window pane adjacent to the rail.

11. The method of claim 10, further comprising:
resizing a body section of the page to align boundaries perpendicular to the rail to parallel edges of the window pane while maintaining aspect ratio of the body section without expanding the body section beyond edges of the window pane.

12. A computing device for navigating a fixed format document in an e-reader application, the computing device comprising:
a memory configured to store instructions; and
a processor coupled to the memory, the processor executing the e-reader application in conjunction with the instructions stored in the memory, wherein the application is configured to:
display a page of the fixed format document resized to match a size of a window pane in one of: a fit page format and a fit width format;
detect a selection action on a text of the page;
present selection controls associated with the selection action;
detect a navigation action on the page; and
execute an operation associated with the navigation action.

13. The computing device of claim 12, wherein the application is further configured to:
highlight the text associated with the selection action; and
display boundary controls adjacent to ends of the text to expand and contract the text.

14. The computing device of claim 13, wherein the application is further configured to:
display at least one of:
a lookup control to display inline insights associated with the text;
an annotation control to add an annotation to the text;
a search control to search for the text within the fixed format document;
a highlight control to highlight the text; and
a define control to display a dictionary definition of the text within the selection controls.

15. The computing device of claim 12, wherein the application is further configured to:
display a view option menu in response to detecting an action on an options control.

16. The computing device of claim 15, wherein the application is further configured to:
display additional controls in the view option menu including at least one of:
a switch to two page view control;
a no auto-fit control;
a fit page control;
a fit width control;
a rotate clockwise control; and
a rotate counterclockwise control.

17. The computing device of claim 16, wherein the application is further configured to:
execute another operation associated with the additional controls in response to activation of one of the additional controls.

18. A computer-readable memory device with instructions stored thereon for navigating a fixed format document in an e-reader application, the instructions comprising:
displaying a page of the fixed format document resized to match a size of a window pane in one of: a fit page format and a fit width format;
detecting a selection action on a text of the page;
highlighting the text associated with the selection action;
displaying boundary controls adjacent to ends of the text to expand and contract the text;
presenting selection controls associated with the selection action;
detecting a navigation action on the page; and
executing an operation associated with the navigation action.

19. The computer-readable memory device of claim 18, wherein the instructions further comprise:
detecting an activation of a search control associated with the text;
executing a search operation associated with the search control to find matching text;
highlighting a matching text; and
displaying a search box including the text to enable a modification of the text in a subsequent search operation using another search control presented in the search box.

20. The computer-readable memory device of claim 18, wherein the instructions further comprise:
analyzing the page for content not associated with a body section of the page;
filtering the page by removing the content not associated with the body section of the page including at least one of: an advertising and an annotation; and
rendering the filtered page.
